(19) United States
(12) Patent Application Publication
(10) Pub. No.: US 2023/0214582 A1
(43) Pub. Date: Jul. 6, 2023

(54) AUTOMATIC IDENTIFYING AND EMPHASIZING OF KEY TEXT

(71) Applicant: CARS.COM, LLC, Chicago, IL (US)

(72) Inventors: Chenwei Wang, Chicago, IL (US); Addhyan Pandey, Chicago, IL (US)

(21) Appl. No.: 17/569,149

(22) Filed: Jan. 5, 2022

(51) Int. Cl. G06F 40/169; G06F 40/106; G06F 40/171; G06K 9/62

(52) U.S. Cl. CPC G06F 40/169; G06F 40/106; G06F 40/171; G06K 9/6256

(57) ABSTRACT

Systems, methods, and computer-readable medium storing instructions for automatically identifying and emphasizing key text of an electronic listing. The method, system, or instructions may include parsing text of the electronic listing to identify a plurality of phrases; applying a scoring algorithm to one or more phrases of the plurality of phrases to determine a score corresponding to each of the one or more phrases; identifying key text of the electronic listing as at least one phrase of the one or more phrases that have a score at least equal to a threshold; marking the key text of the electronic listing for emphasized display; and in response to a request from a user for the electronic listing, causing the text of the listing to be displayed on a display of a user computing device with the key text being emphasized within the text based upon the marking of the key text.

### TECHNICAL FIELD

The present disclosure generally relates to identifying and emphasizing key text in an electronic listing based on a scoring algorithm.

### BACKGROUND

Electronic listings often include text descriptions when selling a good or service. Such text descriptions may be unstructured and are often written by a seller of the good or service. While the text description may include helpful information that is highly relevant to a user in a decision making process of whether or not to purchase the good or service, many text descriptions include other information that is less helpful. For example, helpful information may include information as to why the good or service of the electronic listing is unique as compared to other goods and services in other electronic listings. However, in many electronic listings, the helpful information may be interspersed with and obfuscated by the other information that is less helpful. Existing techniques of presenting text descriptions do not automatically distinguish between key text (i.e., text corresponding to helpful information) and other text (i.e., text corresponding to other information that is less helpful). This problem is of significance for users of electronic listings as it can be difficult for the users to identify helpful information in text descriptions of electronic listings. For example, a particular user of a vehicle listing provider may view hundreds of electronic listings for vehicles and, therefore, may only be able to spend a short amount of time viewing each individual electronic listing. The particular user may not be able to identify helpful information of each electronic listing he or she views given the short amount of time her or she may spend viewing each electronic listing. Accordingly, improved presentation techniques are needed to generate and present more relevant information to users in electronic listing systems.

### SUMMARY

The present application discloses a method, system, and computer-readable medium storing instructions for automatically identifying and emphasizing key text of an electronic listing. The method, system, or instructions may include parsing text of the electronic listing to identify a plurality of phrases; applying a scoring algorithm to one or more phrases of the plurality of phrases to determine a score corresponding to each of the one or more phrases; identifying key text of the electronic listing as at least one phrase of the one or more phrases that have a score at least equal to a threshold; marking the key text of the electronic listing for emphasized display; and in response to a request from a user for the electronic listing, causing the text of the listing to be displayed on a display of a user computing device with the key text being emphasized within the text based upon the marking of the key text.

Some embodiments may include analyzing feedback from the user following the display of the electronic listing, the feedback regarding the emphasizing of the key text within the text; updating the scoring algorithm based on the feedback from the user of the listing. In such embodiments, the feedback from the user may be based on cursor movement of the user on the display of the user computing device in relation to the key text.

Some embodiments may include receiving a training data set comprising a plurality of electronic listings; and generating the scoring algorithm by training a machine learning model using the training data set. In such embodiments, the training data set may be generated by removing one or more repeated phrases from the training data set, wherein each repeated phrases of the one or more repeated phrases is a phrase that is included more than a threshold number of instances in the electronic listings. Some embodiments may include generating the scoring algorithm based on at least a user profile associated with the user.

In some embodiments, the key text is emphasized by one or more of: highlighting the key text, bolding the key text, underlining the key text, italicizing the key text, coloring the key text to be a color different from a color of the text of the listing, or sizing the key text to be a font size different from a font size of the text of the listing.

The user data may comprise site interaction data regarding interaction of the consumer with one or more portions of a web site or a mobile application associated with the vehicle dealer. Additionally or alternatively, the user data may comprise demographic data regarding the consumer, which may include one or more of the following: a location associated with the user, an income associated with the user, an age of the user, price preferences associated with the consumer, or prior vehicle purchases or leases by the consumer.

Some embodiments may include removing one or more of the plurality of phrases based upon such one or more phrases being contained in a list of common phrases to obtain the one or more phrases to which the scoring algorithm is applied.

In various embodiments, additional, fewer, or alternate actions may be included or performed by the method, system, and computer-readable medium, including those discussed elsewhere herein.

### BRIEF DESCRIPTION OF THE DRAWINGS

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 illustrates a block diagram of an exemplary system on which the methods described herein may operate in accordance with the embodiments described herein.

FIG. 2 illustrates a block diagram of an exemplary process for identifying and emphasizing key text of an electronic listing.

FIG. 3 illustrates a flow diagram of an exemplary method for identifying and emphasizing key text of an electronic listing.

FIG. 4 illustrates a flow diagram of an exemplary method for identifying and emphasizing key text of an electronic listing and updating a scoring algorithm based on user feedback.

FIG. 5 illustrates a flow diagram of an exemplary method for identifying and emphasizing key text of an electronic listing based on a trained machine learning model.

### DETAILED DESCRIPTION

The invention described herein aims to reduce problems with conventional approaches of displaying electronic listings. Specifically, systems and methods for identifying and emphasizing key text by applying a scoring algorithm to parsed phrases of an electronic listing are disclosed. Such scoring algorithms may be updated based on user feedback and may be machine learning algorithms generated by training data. Emphasizing key text increases the information value of listings and enables users to quickly identify information that is helpful to their decision making processes, thereby allowing the users to quickly make improved decisions relative to conventional electronic listing displaying methods. Advantageously, the invention described herein may reduce a length of time a user spends looking at electronic listings of goods and services via emphasizing key text, allowing the user to spend their time on other, possibly more important, endeavors. Also advantageously, the invention described herein may reduce a number of transmissions and/or bandwidth consumed in a user's buying experience as emphasizing key text enables the user to more readily identify a good or service that matches their needs/interests after viewing a fewer number of electronic listings, as compared to conventional methods. Also advantageously, the invention described herein may help users avoid making less favorable purchasing decisions due to overlooking key information in listings by emphasizing key information in the text. Additional advantageous to the invention over conventional approaches of displaying electronic listings will be appreciated throughout this disclosure by one having ordinary skill in the art.

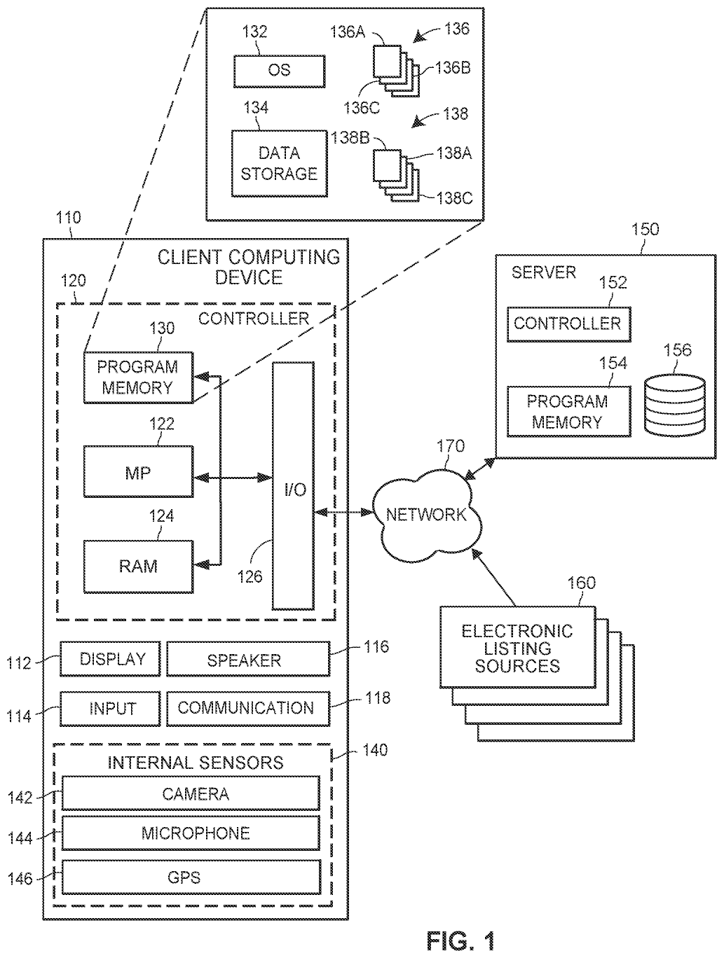

FIG. 1 illustrates a block diagram of an exemplary system on which the methods described herein may operate in accordance with the embodiments described herein. At a high level, the system 100 architecture includes components of a client computing device 110, a server 150, and electronic listing sources 160, all communicatively coupled via a network 170. The client computing device 110 may be a front-end component, and the server 150 and the electronic listing sources 160 may be back-end components. The client computing device 110 may be used by a user to request electronic listings with key text of the electronic listings being emphasized. For example, the client computing device 110 may be used by a user to request and obtain data using one or more software programs, which data may include information regarding vehicles or vehicle dealers. Although one client computing device 110, one server 150, one network 170, and a plurality of electronic listing sources 160 are shown, it should be understood that any number of instances of the components (e.g., one instance, ten instances, one-thousand instances, etc.) may be included in the system 100.

The client computing device 110 may be a desktop computer, a notebook computer, a netbook computer, a smartphone, a tablet computer, a wearable electronic device, or similar mobile or stationary computing device capable of receiving and processing electronic information. The client computing device 110 may include one or more internal sensors 140, which may provide sensor data regarding the local physical environment or the device's location therein. Such internal sensors 140 may likewise facilitate user input to the client computing device 110, such as by enabling the user to issue voice commands via a microphone 144. The client computing device 110 may further communicate with the server 150 via a router (not shown) and/or the network 170 to send and receive data. The data may be processed by the controller 120 to perform various operations for the user. Additionally, or alternatively, the data may be sent to one or more processors of the server 150 through the network 170 for processing. When the controller 120 (or other processor) receives an indication of a user action or request, appropriate responses are determined and implemented. Such responses may include processing data for presentation to the user, requesting data from the server 150, processing data from other front-end components or back end components, determining information regarding the client computing device 110, sending data to the server 150, or presenting information to the user via a display 112 or speakers 116. In some embodiments, the client computing device 110 may include a communication unit 118 to send or receive information from local or remote devices (e.g., the server 150), either directly or through the network 170. The communication unit 118 may include a wireless communication transceiver, such as a Wi-Fi or Bluetooth communication component. Further embodiments of the client computing device 110 may include one or more inputs 114 to receive instructions, selections, or other information from a user of the client computing device 110.

The client computing device 110 may include various input and output components, units, or devices. The display 112 and speakers 116, along with other integrated or communicatively connected output devices (not shown), may be used to present information to the user of the client computing device 110 or others. The display 112 may include any known or hereafter developed visual or tactile display technology, including LCD, OLED, AMOLED, projection displays, refreshable braille displays, haptic displays, or other types of displays. The one or more speakers 116 may similarly include any controllable audible output device or component, which may include a haptic component or device. In some embodiments, communicatively connected speakers 116 may be used (e.g., headphones, Bluetooth headsets, docking stations with additional speakers, etc.). The inputs 114 may further receive information from the user. Such inputs 114 may include a physical or virtual keyboard, a microphone 144, virtual or physical buttons or dials, or other means of receiving information. In some embodiments, the display 112 may include a touch screen or otherwise be configured to receive input from a user, in which case the display 112 and the inputs 114 may be combined.

The client computing device 110 may further include various internal sensors 140. The internal sensors 140 may include any devices or components mentioned herein, other extant or later-developed devices suitable for monitoring a physical environment (including device position or location within the environment). The sensors of the client computing device 110 may further include additional internal sensors 140 specifically configured for determining location or for tracking movement or spatial orientation of the device.

In some embodiments, the client computing device 110 may include a wearable computing device or may be communicatively connected to a wearable computing device. In such embodiments, part or all of the functions and capabilities of the client computing device 110 may be performed by or disposed within the wearable computing device. Additionally, or alternatively, the wearable computing device may supplement or complement the client computing device 110. For example, the wearable computing device 110 may be a smart watch with a display 112, a speaker 116 (or haptic alert unit), an input 114, and one or more internal sensors 140. Such smart watch may be communicatively connected to a smartphone and used interchangeably with the smartphone for some purposes (e.g., displaying information, providing user alerts, etc.).

Although discussion of all possible sensors of the client computing device 110 would be impractical, if not impossible, several sensors warrant particular discussion. Disposed within the client computing device 110, the internal sensors 140 may include a camera 142, a microphone 144, or a GPS unit 146. Any or all of these may be used to generate sensor data regarding the client computing device 110, its environment, user activity, or other relevant information. Additionally, other types of currently available or later-developed sensors may be included in some embodiments.

The GPS unit 146 may provide information regarding the location or movement of the client computing device 110. The GPS unit 146 may use “Assisted GPS” (A-GPS), satellite GPS, or any other suitable global positioning protocol (e.g., the GLONASS system operated by the Russian government) or system that locates the position of the client computing device 110. For example, A-GPS utilizes terrestrial cell phone towers or Wi-Fi hotspots (e.g., wireless router points) to more accurately and more quickly determine location of the client computing device 110, while satellite GPS generally is more useful in more remote regions that lack cell towers or Wi-Fi hotspots. Such sensor data may further be used to determine position of the user over time. For example, position data may be used to determine the length of time a user spends at a particular location, such as examining a particular vehicle on a vehicle dealer lot.

The camera 142 may be used to capture images of vehicles, QR codes or barcodes, or other relevant objects in the user's environment. It should be understood that one or more cameras 142 may be disposed within the client computing device 110 and configured to generate either still images or video recordings. It should further be understood that many smartphones or tablet computers include front and back solid state digital cameras, which may be used to simultaneously obtain images of a large portion of the area before and behind the phone or tablet. In some embodiments, the camera 142 may include a flash or lighting device to illuminate the subject area. The microphone 144 may be used to monitor sounds within the local physical environment. One or more microphones 144 may be disposed within the client computing device 110 or may be communicatively connected thereto. The one or more microphones 144 may be used to record sounds or to receive voice commands from a user.

The client computing device 110 may also communicate with a router or the network 170 using the communication unit 118, which may manage communication between the controller 120 and external devices. The communication unit 118 may transmit and receive wired or wireless communications with external devices, using any suitable wireless communication protocol network, such as a wireless telephony network (e.g., GSM, CDMA, LTE, etc.), a Wi-Fi network (802.11 standards), a WiMAX network, a Bluetooth network, etc. Additionally, or alternatively, the communication unit 118 may also be capable of communicating using a near field communication standard (e.g., ISO/IEC 18092, standards provided by the NFC Forum, etc.). Furthermore, the communication unit 118 may provide input signals to the controller 120 via the I/O circuit 126. The communication unit 118 may also transmit sensor data, device status information, control signals, or other output from the controller 120 to one or more of the network 170 or the server 150.

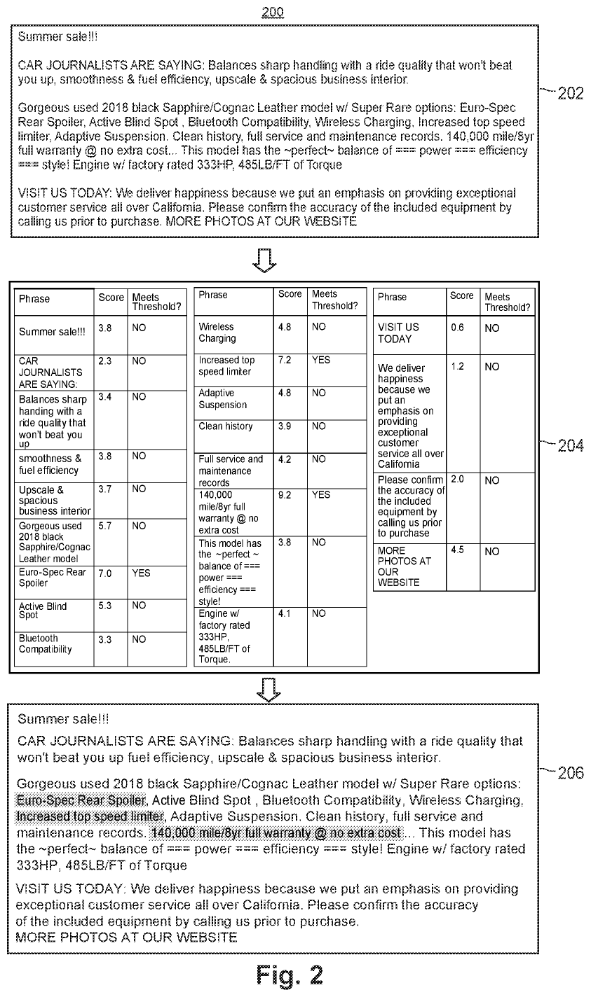

The client computing device 110 may further include a controller 120. The controller 120 may be configured to receive, process, produce, transmit, and store data. The controller 120 may include a program memory 130, one or more microcontrollers or microprocessors (MP) 122, a random access memory (RAM) 124, and an I/O circuit 126. The components of the controller 120 may be interconnected via an address/data bus or other means. It should be appreciated that although FIG. 1 depicts only one microprocessor 122, the controller 120 may include multiple microprocessors 122 in some embodiments. Similarly, the memory of the controller 120 may include multiple RAM 124 or multiple program memories 130. Although the FIG. 2 depicts the I/O circuit 126 as a single block, the I/O circuit 126 may include a number of different I/O circuits, which may be configured for specific I/O operations. The microprocessor 122 may include one or more processors of any known or hereafter developed type, including general-purpose processors or special-purpose processors. Similarly, the controller 120 may implement the RAM 124 and program memories 130 as semiconductor memories, magnetically readable memories, optically readable memories, or any other type of memory.

The program memory 130 may include an operating system 132, a data storage 134, a plurality of software applications 136, and a plurality of software routines 138. The operating system 132, for example, may include one of a plurality of mobile platforms such as the iOS®, Android™, Palm® webOS, Windows® Mobile/Phone, BlackBerry® OS, or Symbian® OS mobile technology platforms, developed by Apple Inc., Google Inc., Palm Inc. (now Hewlett-Packard Company), Microsoft Corporation, Research in Motion (RIM), and Nokia, respectively. The data storage 134 may include data such as user profiles and preferences, application data for the plurality of applications 136, routine data for the plurality of routines 138, and other data necessary to interact with the server 150 through the digital network 170. In some embodiments, the controller 120 may also include, or otherwise be communicatively connected to, other data storage mechanisms (e.g., one or more hard disk drives, optical storage drives, solid state storage devices, etc.) that reside within the client computing device 110. Moreover, in thin-client implementations, additional processing and data storage may be provided by the server 150 via the network 170.

The software applications 136 and routines 138 may include computer-readable instructions that cause the processor 122 to implement data processing and communication functions. Thus, the software applications 136 may include a vehicle information application 136A to obtain and present information regarding vehicles and vehicle dealers, a web browser application 136B to obtain and present web-based content, or a reporting application 136C to generate or present based upon user interactions. The software routines 138 may support the software applications 136 and may include routines such as a communication routine 138A for communicating with the server 150 via the network 170, a data request routine 138B to allow a user to specify parameters for requesting data, and a data presentation routine 138C for generating or presenting received data to the user via the display 112. It should be understood that additional or alternative applications 136 or routines 138 may be included in the program memory 130, including other applications of the sort ordinarily stored on a mobile devices.

The server 150 is a back-end component that stores information received from the front-end components such as the client computing device 110 via the network 170. The server 150 may further provide requested data to the front-end components, such as vehicle data or report data. In some embodiments, a plurality of servers may perform distinct or overlapping functions. For example, a first server may provide data in response to user requests and store information associated with such user requests, while a second server may perform analysis on the data provided by the first server. Alternatively, one server 150 may perform any or all of the functions described herein. The server 150 may include a controller 152 to process data and run software programs, applications, or routines stored in a program memory 154 as executable instructions, and the server 150 may further include or be communicatively connected to a database 156 for data storage and retrieval.

The server 150 may include one or more computer processors within the controller 152 adapted and configured to execute various software applications and routines of the data system 100 stored in the program memory 154, in addition to other software applications. The controller 152 may include one or more processors (not shown), a random-access memory (RAM) (not shown), the program memory 154, and an input/output (I/O) circuit (not shown), all of which may be interconnected via an address/data bus (not shown). The RAM and program memory 154 may be implemented as semiconductor memories, magnetically readable memories, optically readable memories, or any other type of known or hereafter developed memory capable of storing executable instructions for execution by computer processors, such as the controller 152. The server 150 may further include one or more databases 146, which may be adapted to store data received from the front-end components 102, as well as data to be transmitted to the front-end components 102 (e.g., vehicle or vehicle dealer information). Such data might include, for example, information regarding vehicles listed for sale by vehicle dealers, information regarding average prices or ratings for vehicles of specified types, makes, models, or years, information regarding vehicle dealer inventory, hours, or customer ratings, or other information a customer may use in searching for or purchasing a vehicle. The server 150 may access data stored in the database 156 when executing various functions and tasks associated with the data system 100.

The electronic listing sources 160 are back-end components that store electronic listings and electronic listing data. The electronic listing sources 160 may provide information to the server 150 and/or the client computing device 110 automatically, or in response to a request. For example, a user of the client computing device 110 may wish to view an electronic listing, in response, the electronic listing sources 160 may send one or more electronic listings to the client computing device 110 via the network 170, where the client computing device 110 identifies and emphasizes key text of the one or more electronic listings. In other example, the electronic listing source 160 first provides one or more electronic listings to the server 150 via the network 170 such that key text may be identified and emphasized, and then the server 150 provides the one or more electronic listings with the key text emphasized to the client device 110 via the network 170. The electronic listing sources 160 may be databases of electronic listings themselves, or the electronic listing sources 160 may be configured to receive electronic listings. The electronic listing sources 160 may be maintained and/or operated by public or private organizations and may be updated regularly to reflect changes in electronic listing data such as price, photos, description, availability, sales, product restrictions, specifications, etc.

In some embodiments, the front-end components may include a plurality of client computing devices 110 configured to access information from the server 150 and/or the electronic listing sources 160 via the network 170 and to communicate information to the server 150. The front-end components communicate with the back-end components via the network 170. The network 170 may be a proprietary network, a secure public internet, a virtual private network or some other type of network, such as dedicated access lines, plain ordinary telephone lines, satellite links, cellular data networks, combinations of these, etc. Where the network 170 comprises the Internet, data communications may take place over the network 170 via an Internet communication protocol.

FIG. 2 illustrates a block diagram of an exemplary process 200 for identifying and emphasizing key text of an electronic listing. The process 200 depicts text description 202 corresponding to a vehicle of an electronic listing. The process 200 further depicts a data table 204 that includes a plurality of phrases parsed from the text of the electronic listing, scores corresponding to each of the plurality of phrases, and an indication for each phrase of the plurality of phrases of whether the phrase meets a threshold. The process 200 finally depicts an emphasized text description 206 corresponding to the electronic listing. At least some of the process 200 may use the system 100 of FIG. 1.

The text description 202 corresponding to the vehicle of the electronic listing may be written by an author who is a seller of the vehicle or who is writing on behalf of the seller. The seller may be a private seller or a dealer. The text description 202 may be a description of the vehicle. The electronic listing of the vehicle may further include at least one of: images and/or videos of the vehicle, specifications of the vehicle, ratings of the vehicle, a make and a model of the vehicle, seller information, etc. In some embodiments, the text description 202 have may been auto-generated. In some embodiments, there may be limits on how many words or characters may be included in the text description 202. There may also be limits on which words and/or phrases are allowed and/or disallowed from being included in the text description 202. The text description 202 may have some formatting included beyond just plain text; for example, the text description 202 may have paragraphs breaks, bolding, underlining, italicizing, highlighting, or other formatting included. The formatting may have been applied to the text description 202 by the author. There may be limits on which types of formatting are allowable in the text description 202. For example, if emphasizing phrases is to be accomplished via highlighting, there may be a limit preventing the author of the text from applying highlighting to the text description 202.

The text description 202 may have been provided by the electronic listing sources 160 to the server 150 and/or the client computing device 110 via the network 170. The electronic listing sources 160 may have provided the text description 202 either automatically, or in response to a request. The request may have originated from the client computing device 110, for example, due to the user of the client computing device 110 requesting access to a webpage. The text description 202 may be stored by the database 156 of the server 150 and/or at least one of: the RAM 124, the MP 122 or the data storage 134 of the client computing device 110.

The data table 204 includes a plurality of phrases parsed from the text description 202 of the electronic listing. In some embodiments, parsing the text description 202 into the plurality of phrases may include applying a natural language processing model to the text to identify the plurality of phrases. The natural language processing model may be a machine learning model. Such natural language processing may include identifying words, phrases, or groups of words sharing common attributes, such as root, general meanings, formatting, sentence structure, etc. For example, “CAR JOURNALISTS ARE SAYING:” may be parsed as a phrase at least because, for example, all the letters are in all-caps, and/or because all the words between the start of a sentence and a colon. In another example, “Please confirm the accuracy of the included equipment by calling us prior to purchase” may be parsed as a phrase at least because, for example, the words may have been included in every electronic listing written by a seller as “boilerplate” language. Certain words or characters may be omitted from the plurality of phrases. For example, the comma in between “Euro-Spec Rear Spoiler” and “Active Blind Spot” is omitted from the plurality of phrases in the data table 204.

Parsing the text description 202 of the electronic listing may be performed by the server 150 and/or the client computing device 110. Parsing the text description 202 may have been initiated either automatically or in response to a request. The request may have originated from the client computing device 110, for example, due to the user of the client computing device 110 requesting access to a webpage. The plurality of phrases may be stored by the database 156 of the server 150 and/or at least one of: the RAM 124, the MP 122 or the data storage 134 of the client computing device 110.

The data table 204 includes scores corresponding to each of the plurality of phrases. The scores may be calculated by a scoring algorithm. The scoring algorithm may be generated by training a machine learning model. The machine learning model may be trained using a supervised or unsupervised machine-learning program or algorithm. The machine-learning program or algorithm may employ a neural network, which may be a convolutional neural network, a deep learning neural network, or a combined learning module or program that learns in two or more features or feature datasets in a particular areas of interest. In one embodiment, a generative adversarial neural network may be used. The machine-learning programs or algorithms may also include natural language processing, semantic analysis, automatic reasoning, regression analysis, support vector machine (SVM) analysis, decision tree analysis, random forest analysis, K-Nearest neighbor analysis, naïve Bayes analysis, clustering, reinforcement learning, and/or other machine-learning algorithms and/or techniques. Machine-learning may involve identifying and recognizing patterns in existing data in order to facilitate making predictions for subsequent data. In some embodiments, due to the processing power requirements of training machine learning models, the selected model may be trained using additional computing resources (e.g., cloud computing resources) based upon data provided by the server 150. A training data set may include phrases which are related to the scoring algorithm. For example, if the scoring algorithm is being trained for use in vehicle electronic listings, the training data set may include phrases related to vehicles. The training data set may be unlabeled, or the training data set may be labeled, such as by a human. The training data set may be generated by removing one or more repeated phrases from the training data set, wherein each repeated phrase of the one or more repeated phrases is a phrase that is included more than a threshold number of instances in electronic listings of the training data set.

Training of the scoring algorithm may continue until at least one model of the scoring algorithm is validated and meets selection criteria to be used as a predictive model. In one embodiment, each scoring algorithm may be validated using a second subset of the training data set to determine algorithm accuracy and robustness. Such validation may include applying the scoring algorithm to the training data set of the second subset of training data set to predict scores of some phrases. The scoring algorithm may then be evaluated to determine whether the scoring algorithm performance is sufficient based upon the validation stage predicted scores. The sufficiency criteria applied may vary depending upon the size of the training data set available for training, the performance of previous iterations of scoring algorithms, or user-specified performance requirements. In another embodiment, the scoring algorithm may be validated using feedback. In some embodiments, the feedback may be user feedback. The user feedback may include asking a user if phrases receiving a high score from the trained model are important to their purchase decision making process. The user feedback may include behavior such as at least one of: cursor movement, clicking, highlighting and/or copying text, scrolling behavior, zooming behavior, or other behavior of the user on the electronic listing. The behavior may be used to determine if the scoring algorithm is accurate in its scoring. For example, if a user hovers their cursor over a phrase for a certain amount of time, this may be an indication the user finds the phrase to contain information important to their purchase decision making process. When a scoring algorithm has not achieved sufficient performance, additional training may be performed, which may include refinement of the scoring algorithm or retraining on a different first subset of the training data set, after which the new scoring algorithm may again be validated and assessed. When the scoring algorithm has achieved sufficient performance, the scoring algorithm may be stored for later use. The server 150 and/or the client computing device 110 may store the one or more selected scoring algorithms for later use according to the methods and techniques disclosed herein. The scoring algorithms may be stored as sets of parameter values or weights for analysis of further user interaction data or user data, which may also include analysis logic or indications of model validity in some instances. In some embodiments, trained predictive models may be stored in the database 156 associated with server 150.

The scoring algorithm may be universal, (i.e., applicable to all users in all circumstances) or the scoring algorithm may be more specific (i.e., different for different users with different user profiles and/or different circumstances). For example, the data table 204 depicts the phrase “Euro-Spec Rear Spoiler” as having a relatively high score as compared to all the other phrases of the plurality of phrases. Not every user may find information on the vehicle's spoiler to be useful; however, for a user who has been determined to be interested in performance and/or aesthetics of vehicles, such as a car-enthusiast, this phrase may be particularly important and accordingly scored higher. Similarly, the car-enthusiast user may also find the phrase “Increased top speed limiter” to be particularly important and accordingly this phrase would be scored higher. User profile information which may influence scores of phrases may include, for example, demographics of the user, income and/or wealth information of the user, location of the user, search history and/or behavior of the user, the user's interest in cars, current vehicle and/or mode of transportation used by user, etc. Some phrases may be scored differently depending on circumstances. For example, the phrase “Euro-Spec Rear Spoiler” may be scored differently depending on whether or not the vehicle is located in Europe. Circumstances which may influence scores of phrases may include, for example, location of the vehicle, time of day, time of year, weather, sales data for the vehicle or similar vehicles, economic and/or social trends, etc. Some phrases may be universally unimportant, such as, “Bluetooth Compatibility,” which may be unimportant, for example, because for 2018 model year vehicles, Bluetooth compatibility may be a common feature. Some phrases may be universally important, such as, “140,000 mile/8 yr full warranty @ no extra cost,” which may be important, for example, because this may be an unusually long warranty period that does not increase purchase price. Some phrases may have an override to adjust their score, such as, “MORE PHOTOS AT OUR WEBSITE,” which may be a phrase that users frequently move their cursor over (or click, if the text corresponds to a hyperlink); however, the score may be reduced as the phrase may undesirably redirect web traffic from the electronic listing host website to another website and may be of secondary usefulness to the user after the user has already determined the vehicle is otherwise of interest.

Scoring the plurality of phrases may be performed by the server 150 and/or the client computing device 110. Scoring the plurality of phrases may have been initiated either automatically, or in response to a request. The request may have originated from the client computing device 110, for example, due to the user of the client computing device 110 requesting access to a webpage. The scores corresponding to the plurality of phrases may be stored by the database 156 of the server 150 and/or at least one of: the RAM 124, the MP 122 or the data storage 134 of the client computing device 110.

The data table 204 includes an indication for each phrase of the plurality of phrases of whether the phrase meets a threshold. One or more phrases which meet the threshold may be known as “key text.” In the example data table 204, scores may range from 0.0 to 10.0 with the threshold set at 7.0. Based on the threshold being 7.0, all phrases of the plurality of phrases which have a score of at least 7.0 are marked as meeting the threshold in the data table 204. If none of the scores meet the threshold, none of the phrases may be emphasized. In some embodiments, if multiple phrases meet the threshold, only a phrase corresponding to the highest score will be emphasized, and accordingly may be referred to as the “key text.” In some embodiments, there may be a plurality of thresholds, for example, there may be two thresholds, wherein a first threshold may correspond to a first type of emphases (e.g., bolding text corresponding to phrases meeting the first threshold) and a second threshold may correspond to a second type of emphases (e.g., highlighting text corresponding to phrases meeting the second threshold). In some embodiments, the threshold may not be a score, but some other cutoff. For example, in this embodiment, the threshold may be that whichever two phrases have highest scores, regardless of how high the scores corresponding to the two phrases are, will be key text that are emphasized.

Determining whether each phrase of the plurality of phrases meets the threshold may be performed by the server 150 and/or the client computing device 110. Determining whether each phrase of the plurality of phrases meets the threshold may have been initiated either automatically, or in response to a request. The request may have originated from the client computing device 110, for example, due to the user of the client computing device 110 requesting access to a webpage. The determination of whether each phrase of the plurality of phrases meets the threshold may be stored by the database 156 of the server 150 and/or at least one of: the RAM 124, the MP 122 or the data storage 134 of the client computing device 110.

The emphasized text description 206 corresponding to the electronic listing is based on the indication of whether the phrase meets a threshold that is recorded in the data table 204 for each phrase of the plurality of phrases. In the illustrated example, text which is emphasized in the emphasized text description 206 corresponds to three phrases in the data table 204 which had a score meeting the threshold. In this example, the three phrases are key text. The emphasized text description 206 depicts the key text as being highlighted. However, key text may be emphasized in the emphasized text description 206 in a variety of different ways, including by one or more of: highlighting the key text, bolding the key text, underlining the key text, italicizing the key text, coloring the key text to be a color different from a color of other text (the other text being text of the emphasized text description 206 which is not the key text), or sizing the key text to be a font size different from a font size of the other text. In some embodiments, emphasizing the key text may be accomplished by de-emphasizing either some or all of the other text. De-emphasizing the other text in the emphasized text description 206 may include one or more of: sizing the other text to be a font size small than the key text (e.g., sizing the other text to a smaller font size than the key text), coloring the other text to be a color other than the key text (e.g., coloring the other text a to lighter color than the key text), or removing at least some of the other text. In some embodiments, emphasizing the key text may be accomplished by displaying the key text separate from the other text, such as by displaying the key text in a different section of the electronic listing, possibly in a different structured or unstructured data type. In some embodiments, the emphasized text description 206 is displayed on the display 112 of the client computing device 110. In other embodiments, the emphasized text description 206 is read aloud to the user using the speaker 116 of the client computing device 110. In this embodiment where the emphasized text description 206 is read aloud to the user (e.g., as audio output of a digital assistant device), different types of emphasizing key text may be used, such as, for example: reading the key text with different inflections than the other key, reading the key text at a different volume than the other text, adding pauses around the key text, or not reading some or all of the other text.

The emphasized text description 206 may be displayed on the display 112 of the client computing device 110 either automatically, or in response to a request. The request may have originated from the client computing device 110, for example, due to the user of the client computing device 110 requesting access to a webpage. In the embodiment where the server 150 generates the emphasized text description 206, the client computing device may receive the emphasized text description 206 from the server 150 via the network 170. The emphasized text description 206 may be stored by the database 156 of the server 150 and/or at least one of: the RAM 124, the MP 122 or the data storage 134 of the client computing device 110.

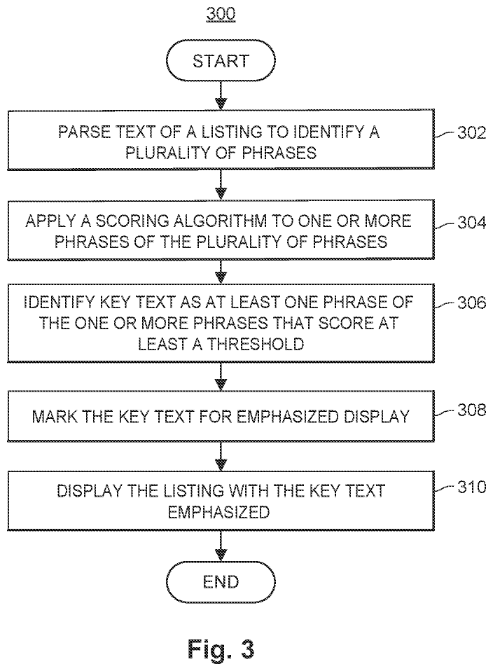

FIG. 3 illustrates a flow diagram of an exemplary method 300 for identifying and emphasizing key text of an electronic listing. The method includes parsing text of an electronic listing to identify a plurality of phrases (block 302), applying a scoring algorithm to one or more phrases of the plurality of phrases (block 304), identifying key text as at least one phrase of the one or more phrases that score at least a threshold (block 306), marking the key text for emphasized display (block 308), and displaying the electronic listing with the key text emphasized (block 310). At least some of the method 300 may use the system 100 of FIG. 1.

The method 300 may begin, in some embodiments, with parsing text of an electronic listing to identify a plurality of phrases (block 302). The electronic listing may have been provided by the electronic listing sources 160 to the server 150 and/or the client computing device 110 via the network 170. At block 302, the server and/or the client device may parse the text of the electronic listing to identify a plurality of phrases. In some embodiments, parsing the text description 202 into the plurality of phrases may include applying a natural language processing model to the text to identify the plurality of phrases. The natural language processing model may be a machine learning model. Such natural language processing may include identifying words, phrases, or groups of words sharing common attributes, such as root, general meanings, formatting, sentence structure, etc. Parsing the text of the electronic listing may be performed by the server 150 and/or the client computing device 110. Parsing the text may have been initiated either automatically, or in response to a request. The request may have originated from the client computing device 110, for example, due to the user of the client computing device 110 requesting access to a webpage. The plurality of phrases may be stored by the database 156 of the server 150 and/or at least one of: the RAM 124, the MP 122 or the data storage 134 of the client computing device 110.

At block 304, a scoring algorithm may be applied to one or more phrases of the plurality of phrases to determine a score corresponding to each phrase of the one or more phrases. The scoring algorithm may be universal, (i.e., applicable to all users in all circumstances) or the scoring algorithm may be more specific (i.e., different for different users with different user profiles and/or different circumstances). User profile information which may influence scores of phrases may include, for example, demographics of the user, income and/or wealth information of the user, location of the user, search history and/or behavior of the user, the user's interest in cars, current vehicle and/or mode of transportation used by user, etc. Circumstances which may influence scores of phrases may include, for example, location of the vehicle, time of day, time of year, weather, sales data for the vehicle or similar vehicles, economic and/or social trends, etc. In some embodiments, the scoring algorithm may be configured to exclude (e.g., by giving scores of zero) certain generic phrases in order to further increase the information value of key text to be displayed to users. Such generic phrases may include repeated phrases identified as being frequently repeated across all listings during training of or specification of the scoring algorithm. In further embodiments, such generic phrases may include phrases repeated in multiple listings by the same listing entity (e.g., in a set of listings associated with the same vehicle dealer) with a frequency above a threshold frequency (e.g., phrases found in more than three-quarters of the vehicle dealer's listings). Such listing entity-specific repeated phrases may be excluded or given reduced scores due to their generic nature with respect to listings of the particular listing entity. For example, a phrase such as “MORE PHOTOS AT OUR WEBSITE” may be included in all listings by a dealer but provides limited informational value to the user.

The scoring algorithm may be stored as sets of parameter values or weights for analysis of further user interaction data or user data, which may also include analysis logic or indications of model validity in some instances. The scoring algorithm may be stored by the database 156 of the server 150 and/or at least one of: the RAM 124, the MP 122 or the data storage 134 of the client computing device 110. Scoring the plurality of phrases may be performed by the server 150 and/or the client computing device 110. Scoring the plurality of phrases may have been initiated either automatically, or in response to a request. The request may have originated from the client computing device 110, for example, due to the user of the client computing device 110 requesting access to a webpage. The scores corresponding to the plurality of phrases may be stored by the database 156 of the server 150 and/or at least one of: the RAM 124, the MP 122 or the data storage 134 of the client computing device 110.

At block 306, at least one phrase of the one or more phrases that have a score at least equal to a threshold may be identified as key text. The threshold may be a numeric score a phrase must equal or exceed in order to be identified as key text. In some embodiments, if none of the one or more phrases correspond to a score meeting the threshold, none of the phrases may be key text. In other embodiments, if none of the one or more phrases correspond to a score meeting the threshold, a phrase of the one or more phrases corresponding to a highest score may be identified as key text. In some embodiments, there may be a plurality of thresholds. In some embodiments, the threshold may not be a score, but some other cutoff such as a percentile, wherein phrases corresponding to scores which are at least in the top percentile of scores may be identified as key phrases. Identifying key text may be performed by the server 150 and/or the client computing device 110. Identifying key text may have been initiated either automatically, or in response to a request. The request may have originated from the client computing device 110, for example, due to the user of the client computing device 110 requesting access to a webpage. The identified key text may be stored by the database 156 of the server 150 and/or at least one of: the RAM 124, the MP 122 or the data storage 134 of the client computing device 110.

At block 308, the key text may be marked for emphasized display. Marking the key text for emphasized display may be performed by the server 150 and/or the client device 110. Marking the key text may include at least one of: storing the key text in a database or location, setting pointers to point at the key text, generating a list of the key text, tagging the key text within a mark-up language representation of the electronic listing text (e.g., inserting tags to identify the key text within an XML version of the listing), or other suitable methods of distinguishing the key text. Marking the text may have been initiated either automatically, or in response to a request. The request may have originated from the client computing device 110, for example, due to the user of the client computing device 110 requesting access to a webpage. The marked key text may be stored by the database 156 of the server 150 and/or at least one of: the RAM 124, the MP 122 or the data storage 134 of the client computing device 110.

At block 310, the electronic listing may be displayed with the key text emphasized, where the key text which is emphasized corresponds to the marked key text. The key text may be emphasized in the electronic listing in a variety of different ways, including by one or more of: highlighting the key text, bolding the key text, underlining the key text, italicizing the key text, coloring the key text to be a color different from a color of the other text, or sizing the key text to be a font size different from a font size of the other text. In some embodiments, emphasizing the key text may be accomplished by de-emphasizing either some or all of the other text. De-emphasizing the other text in the electronic listing may include one or more of: sizing the other text to be a font size smaller than the key text (e.g., sizing the other text to a smaller font size than the key text), coloring the other text to be a color other than the key text (e.g., coloring the other text a to lighter color than the key text), or removing at least some of the other text. In some embodiments, emphasizing the key text may be accomplished by displaying the key text separate from the other text, such as by displaying the key text in a different section of the electronic listing, possibly in a different structured or unstructured data type. In some embodiments, the electronic listing with the key text emphasized is displayed on the display 112 of the client computing device 110. In other embodiments, the electronic listing with the key text emphasized is read aloud to the user using the speaker 116 of the client computing device 110. In this embodiment where the electronic listing with the key text emphasized is read aloud to the user, different types of emphasizing key text may be used, such as, for example: reading the key text with different inflections than the other text, reading the key text at a different volume than the other text, adding pauses around the key text, or not reading some or all of the other text. The electronic listing with the key text emphasized may be displayed on the display 112 of the client computing device 110 either automatically, or in response to a request. The request may have originated from the client computing device 110, for example, due to the user of the client computing device 110 requesting access to a webpage. In the embodiment where the server 150 generates the electronic listing with the key text emphasized, the client computing device may receive the electronic listing with the key text emphasized from the server 150 via the network 170. The electronic listing with the key text emphasized may be stored by the database 156 of the server 150 and/or at least one of: the RAM 124, the MP 122 or the data storage 134 of the client computing device 110. The method 300 may end, in some embodiments, with displaying the listing with the key text emphasized.

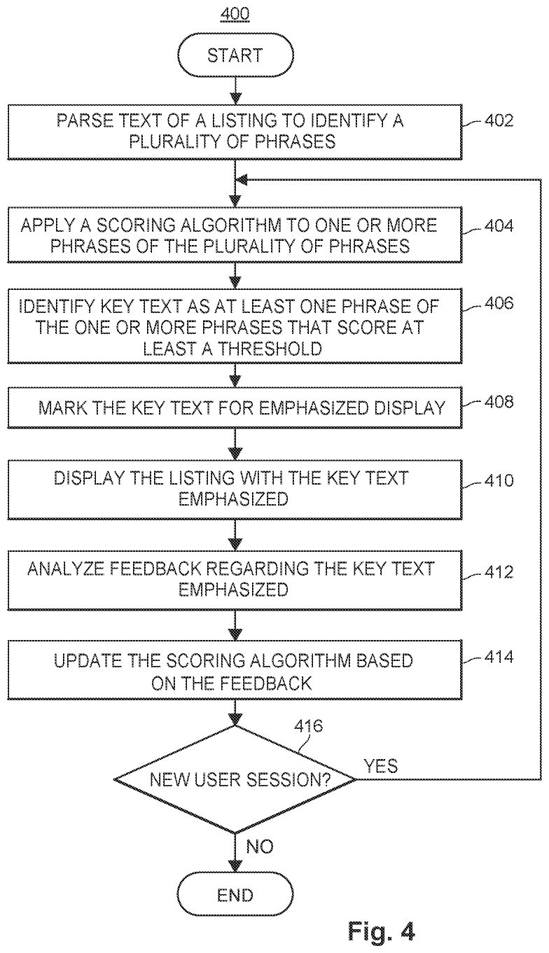

FIG. 4 illustrates a flow diagram of an exemplary method 400 for identifying and emphasizing key text of an electronic listing and updating a scoring algorithm based on user feedback. The method 400 includes parsing text of an electronic listing to identify a plurality of phrases (block 402), applying a scoring algorithm to one or more phrases of the plurality of phrases (block 404), identifying key text as at least one phrase of the one or more phrases that score at least a threshold (block 406), marking the key text for emphasized display (block 408), displaying the electronic listing with the key text emphasized (block 410), analyzing feedback regarding the key text emphasized in the electronic listing (block 412), updating the scoring algorithm based on the feedback (block 414), and, if a new user session has initiated (block 416), returning to block 404. At least some of the method 400 may use the system 100 of FIG. 1.

The method 400 may begin, in some embodiments, with parsing text of an electronic listing to identify a plurality of phrases, score the phrases to identify key text, and mark and display the key text, as discussed above. Thus, block 402, block 404, block 406, block 408, and block 410 may each be similar to or equivalent to each of block 302, block 304, block 306, block 308 and block 310, respectively.

At block 412, feedback regarding the key text emphasized in the electronic listing is analyzed. In some embodiments, the feedback may be user feedback. The user feedback may include asking a user if the key text is important to their purchase decision making process. The user feedback may include behavior such as at least one of: cursor movement, clicking, highlighting and/or copying text, scrolling behavior, zooming behavior, or other behavior of the user on the electronic listing. The behavior may be used to determine if the scoring algorithm is accurate in its scoring. Analyzing feedback regarding the key text may be performed by the server 150 and/or the client computing device 110. Analyzing feedback regarding the key text may have been initiated either automatically, or in response to a request. The plurality of phrases may be stored by the database 156 of the server 150 and/or at least one of: the RAM 124, the MP 122 or the data storage 134 of the client computing device 110.

At block 414, the scoring algorithm may be updated based on the feedback. Updating the scoring algorithm may include, for example, changing parameter values or weights. When the scoring algorithm has been updated, the scoring algorithm may be stored for later use according to the methods and techniques disclosed herein. The scoring algorithms may be stored as sets of parameter values or weights for analysis of further user interaction data or user data, which may also include analysis logic or indications of model validity in some instances. In some embodiments, the scoring algorithm may be stored by the database 156 of the server 150 and/or at least one of: the RAM 124, the MP 122 or the data storage 134 of the client computing device 110.

After the scoring algorithm is updated based on the feedback, the method 400 may end. In other embodiments, it may be determined that a new user session (block 416) has been initiated either by the user or a different user accessing either the electronic listing or a different electronic listing. In this embodiment, once the new user session is initiated, the method 400 may return to block 404 and score one or more phrases of the plurality of phrases using the updated scoring algorithm. Following scoring the one or more phrases using the updated scoring algorithm, the method 400 may continue to block 406, block 408, block 410, block 412, and block 414. At block 412, new feedback may be received regarding the new key text displayed in block 410. Based on the feedback, the scoring algorithm may be updated again at block 414 and may continue in a repetitive manner, returning to block 404, with initiating of additional new user session(s).

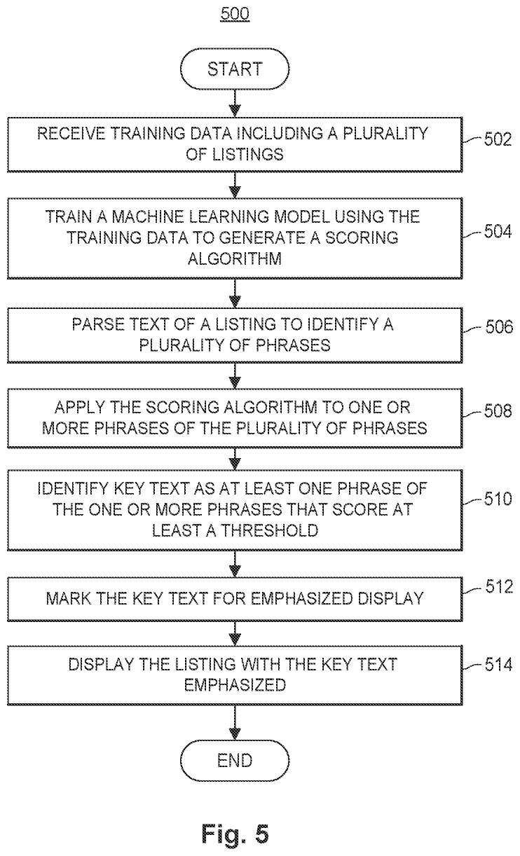

FIG. 5 illustrates a flow diagram of an exemplary method 500 for identifying and emphasizing key text of an electronic listing based on a trained machine learning model. The method 500 includes receiving a training data set including a plurality of listings (block 502), training a machine learning model using the training data set to generate a scoring algorithm (block 504), parsing text of an electronic listing to identify a plurality of phrases (block 506), applying a scoring algorithm to one or more phrases of the plurality of phrases (block 508), identifying key text as at least one phrase of the one or more phrases that score at least a threshold (block 510), marking the key text for emphasized display (block 512), and displaying the electronic listing with the key text emphasized (block 514). At least some of the method 500 may use the system 100 of FIG. 1.

The method 500 may begin, in some embodiments, with receiving the training data set including a plurality of electronic listings (block 502). The training data set may include phrases which are related to the scoring algorithm. The training data set may be unlabeled, or the training data set may be labeled, such as by a human. The training data set may be generated by removing one or more repeated phrases from the training data set, wherein each repeated phrase of the one or more repeated phrases is a phrase that is included more than a threshold number of instances in electronic listings of the training data. Such repeated phrases may be identified generally across the training data set, specifically for each listing entity associated with a minimum threshold number of listings, or both generally and specifically. In some embodiments, the training data set may be provided by the electronic listing sources 160. In some embodiments, the training data set may be stored by the database 156 of the server 150 and/or at least one of: the RAM 124, the MP 122 or the data storage 134 of the client computing device 110.

At block 504, a machine learning model may be trained using the training data set to generate a scoring algorithm. The scoring algorithm may be used to calculate scores of phrases, wherein the scores may indicate a possible importance of a phrase to a user's purchase decision making process. The machine learning model may be trained using a supervised or unsupervised machine-learning program or algorithm. The machine-learning program or algorithm may employ a neural network, which may be a convolutional neural network, a deep learning neural network, or a combined learning module or program that learns in two or more features or feature datasets in a particular areas of interest. In one embodiment, a generative adversarial neural network may be used. The machine-learning programs or algorithms may also include natural language processing, semantic analysis, automatic reasoning, regression analysis, support vector machine (SVM) analysis, decision tree analysis, random forest analysis, K-Nearest neighbor analysis, naïve Bayes analysis, clustering, reinforcement learning, and/or other machine-learning algorithms and/or techniques. Machine-learning may involve identifying and recognizing patterns in existing data in order to facilitate making predictions for subsequent data. In some embodiments, due to the processing power requirements of training machine learning models, the selected model may be trained using additional computing resources (e.g., cloud computing resources) based upon data provided by the server 150.

Training of the scoring algorithm may continue until at least one model of the scoring algorithm is validated and meets selection criteria to be used as a predictive model. In one embodiment, each scoring algorithm may be validated using a second subset of the training data set to determine algorithm accuracy and robustness. Such validation may include applying the scoring algorithm to the training data set of the second subset of training data set to predict scores of some phrases. The scoring algorithm may then be evaluated to determine whether the scoring algorithm performance is sufficient based upon the validation stage predicted scores. The sufficiency criteria applied may vary depending upon the size of the training data set available for training, the performance of previous iterations of scoring algorithms, or user-specified performance requirements. When a scoring algorithm has not achieved sufficient performance, additional training may be performed, which may include refinement of the scoring algorithm or retraining on a different first subset of the training data set, after which the new scoring algorithm may again be validated and assessed. When the scoring algorithm has achieved sufficient performance, the scoring algorithm may be stored for later use. The server 150 and/or the client computing device 110 may store the one or more selected scoring algorithms for later use according to the methods and techniques disclosed herein. The scoring algorithms may be stored as sets of parameter values or weights for analysis of further user interaction data or user data, which may also include analysis logic or indications of model validity in some instances. In some embodiments, the scoring algorithm may be stored by the database 156 of the server 150 and/or at least one of: the RAM 124, the MP 122 or the data storage 134 of the client computing device 110.

In some embodiments, after block 504, the method 500 may advance to block 506, block 508, block 510, block 512, and block 514, each of which may each be similar to or equivalent to each of block 302, block 304, block 306, block 308 and block 310, respectively. In some embodiments, after bock 514, the method 500 may end. In some embodiments, after block 514, the method may analyze feedback regarding the key text emphasized (similar or equivalent to block 412), update the scoring algorithm based on the feedback (similar or equivalent to block 414), and, if a new user session (similar or equivalent to block 416) is initiated, the method 500 may returns to block 508 (similar or equivalent to method 400).

### Other Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

This detailed description is to be construed as exemplary only and does not describe every possible embodiment, as describing every possible embodiment would be impractical, if not impossible. One could implement numerous alternate embodiments, using either current technology or technology developed after the filing date of this application.

Upon reading this disclosure, those of skill in the art will appreciate still additional alternative structural and functional designs for systems and methods according to the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

Although the foregoing text sets forth a detailed description of numerous different embodiments, it should be understood that the legal scope of the invention is defined by the words of the claims set forth at the end of this patent. The particular features, structures, or characteristics of any specific embodiment may be combined in any suitable manner and in any suitable combination with one or more other embodiments, including the use of selected features without corresponding use of other features. It is to be understood that other variations and modifications of the embodiments of the present invention described and illustrated herein are possible in light of the teachings herein and are to be considered part of the spirit and scope of the present invention. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for the sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

What is claimed is:

1. A computer-implemented method for emphasizing phrases of an electronic listing, comprising:
parsing, by one or more processors, text of the electronic listing to identify a plurality of phrases;
applying, by the one or more processors, a scoring algorithm to one or more phrases of the plurality of phrases to determine a score corresponding to each of the one or more phrases;
identifying, by the one or more processors, key text of the electronic listing as at least one phrase of the one or more phrases that have a score at least equal to a threshold;
marking, by the one or more processors, the key text of the electronic listing for emphasized display; and
in response to a request from a user for the electronic listing, causing, by the one or more processors, the text of the listing to be displayed on a display of a user computing device with the key text being emphasized within the text based upon the marking of the key text.

2. The method of claim 1, further comprising:
analyzing, by the one or more processors, feedback from the user following the display of the electronic listing, the feedback regarding the emphasizing of the key text within the text; and
updating, by the one or more processors, the scoring algorithm based on the feedback from the user of the listing.

3. The method of claim 2, wherein the feedback from the user is based on cursor movement of the user on the display of the user computing device in relation to the key text.

4. The method of claim 1, further comprising:
receiving, by the one or more processors, a training data set comprising a plurality of electronic listings; and
generating, by the one or more processors, the scoring algorithm by training a machine learning model using the training data set.

5. The method of claim 4, wherein generating the training data set comprises removing one or more repeated phrases from the training data set, wherein each repeated phrase of the one or more repeated phrases is included more than a threshold number of instances in the electronic listings.

6. The method of claim 1, further comprising:
generating, by the one or more processors, the scoring algorithm based on at least a user profile associated with the user.

7. The method of claim 1, wherein the key text is emphasized by one or more of: highlighting the key text, bolding the key text, underlining the key text, italicizing the key text, coloring the key text to be a color different from a color of the text of the listing, or sizing the key text to be a font size different from a font size of the text of the listing.

8. The method of claim 1, further comprising:
removing, by the one or more processors, one or more of the plurality of phrases based upon such one or more phrases being contained in a list of common phrases to obtain the one or more phrases to which the scoring algorithm is applied.

9. A computer system for emphasizing phrases of an electronic listing, comprising:
one or more processors;
a program memory coupled to the one or more processors and storing executable instructions that, when executed by the one or more processors, cause the computer system to:
parse text of the electronic listing to identify a plurality of phrases;
apply a scoring algorithm to one or more phrases of the plurality of phrases to determine a score corresponding to each of the one or more phrases;
identify key text of the electronic listing as at least one phrase of the one or more phrases that have a score at least equal to a threshold;
mark the key text of the electronic listing for emphasized display; and
in response to a request from a user for the electronic listing, cause the text of the listing to be displayed on a display of a user computing device with the key text being emphasized within the text.

10. The computer system of claim 9, wherein the executable instructions further cause the computer system to:
analyze feedback from the user following the display of the electronic listing, the feedback regarding the emphasizing of the key text within the text; and
update the scoring algorithm based on the feedback from the user of the listing.

11. The computer system of claim 9, wherein the feedback from the user is based on cursor movement of the user on the display of the user computing device in relation to the key text.

12. The computer system of claim 9, wherein the executable instructions further cause the computer system to:
receive a training data set comprising a plurality of electronic listings; and
generate the scoring algorithm by training a machine learning model using the training data set.

13. The computer system of claim 12, wherein generating the training data set comprises removing one or more repeated phrases from the training data set, wherein each repeated phrase of the one or more repeated phrases is included more than a threshold number of instances in the electronic listings.

14. The computer system of claim 9, wherein the executable instructions further cause the computer system to:
generate the scoring algorithm based on at least a user profile associated with the user.

15. The computer system of claim 9, wherein the key text is emphasized by one or more of: highlighting the key text, bolding the key text, underlining the key text, italicizing the key text, coloring the key text to be a color different from a color of the text of the listing, or sizing the key text to be a font size different from a font size of the text of the listing.

16. A tangible, non-transitory computer-readable medium storing executable instructions for emphasizing phrases of an electronic listing that, when executed by one or more processors of a computer system, cause the computer system to:
parse text of the electronic listing to identify a plurality of phrases;
apply a scoring algorithm to one or more phrases of the plurality of phrases to determine a score corresponding to each of the one or more phrases;
identify key text of the electronic listing as at least one phrase of the one or more phrases that have a score at least equal to a threshold;
mark the key text of the electronic listing for emphasized display; and
in response to a request from a user for the electronic listing, cause the text of the listing to be displayed on a display of a user computing device with the key text being emphasized within the text.

17. The tangible, non-transitory computer-readable medium of claim 16, wherein the executable instructions further cause the computer system to:
analyze feedback from the user following the display of the electronic listing, the feedback regarding the emphasizing of the key text within the text; and
update the scoring algorithm based on the feedback from the user of the listing.

18. The tangible, non-transitory computer-readable medium of claim 16, wherein the executable instructions further cause the computer system to:
receive a training data set comprising a plurality of electronic listings; and
generate the scoring algorithm by training a machine learning model using the training data set.

19. The tangible, non-transitory computer-readable medium of claim 16, wherein the executable instructions further cause the computer system to:
generate the scoring algorithm based on at least a user profile associated with the user.

20. The tangible, non-transitory computer-readable medium of claim 16, wherein the key text is emphasized by one or more of: highlighting the key text, bolding the key text, underlining the key text, italicizing the key text, coloring the key text to be a color different from a color of the text of the listing, or sizing the key text to be a font size different from a font size of the text of the listing.
